(19) United States
(12) Patent Application Publication
(10) Pub. No.: US 2009/0288962 A1
(43) Pub. Date: Nov. 26, 2009

(54) Electrochemical Sensor and Methods for Making and Using Same

(75) Inventors: Wassana Yantasee, Richland, WA (US); Glen E. Fryxell, Kennewick, WA (US); Raymond S. Addleman, Benton City, WA (US); Yuehe Lin, Richland, WA (US); Charles Timchalk, Kennewick, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/427,431

(22) Filed: Apr. 21, 2009

Related U.S. Application Data
(60) Provisional application No. 61/054,971, filed on May 21, 2008.

(51) Int. Cl. G01N 27/30; B05D 5/12; G01N 27/26

(52) U.S. Cl. 205/790; 204/403.15; 427/58; 436/149

(57) ABSTRACT

A mercury-free, electrochemical sensor is described that includes a self-assembled monolayer on a mesoporous support (SAMMS) composite and a fluoropolymer component that is deposited on a measurement surface. The SAMMS component provides outstanding metal preconcentration. The fluoropolymer component acts as an antifouling binder. The sensor can detect various metals at a low detection level in the presence of fouling agents and without sample pretreatment. The sensor is also able to detect mixtures of metals simultaneously with excellent single and inter-electrode reproducibility. Service lifetimes are excellent.

### CROSS REFERENCE TO RELATED APPLICATION

This application claims priority from Provisional application number 61/054,971 filed 21 May 2008, now abandoned, which application is incorporated herein in its entirety.

This invention was made with Government support under Contract DE-AC0676RLO-1830 awarded by the U.S. Department of Energy. The Government has certain rights in the invention.

### FIELD OF THE INVENTION

The present invention relates generally to electrodes and electrochemical sensors. More particularly, the invention relates to a functionalized electrode sensor and methods for making and using same. The invention finds application in, e.g., determination of metals in environmental, medical, and biological samples that are subject to fouling, e.g., biofouling.

### BACKGROUND OF THE INVENTION

Electrochemical sensors have great potential for environmental and biological monitoring of toxic metal ions in water and biological samples (e.g., blood and urine) due to their portability and field deployability, excellent sensitivity (in low ppb levels), automation, short analysis time, low power consumption, and inexpensive equipment. However, a problem preventing wide application of electrochemical sensors for metal ion monitoring relates to use and disposal of mercury deployed conventionally as a metal preconcentrator. Electrochemical sensors that employ mercury-based approaches and mercury-free approaches typically suffer from fouling due to organic substances and surfactants present in the sampling medium. In addition, binding competition for metal ions in the fluid medium, e.g., in water, can also make sample pretreatment necessary. To avoid use of mercury in the detection of Cd and Pb, researchers have used silver electrodes, gold electrodes, glassy-carbon discs, and silver-coated and bismuth-coated carbon electrodes. Other classes of mercury-free electrodes rely on chemical modification for the required metal preconcentration. Various ligands may be immobilized on the electrode surfaces using conductive binders (e.g., carbon paste). However, because these ligands are in loose association with the binders, degradation of the sensors can occur due to depletion of the ligands during measurements. Most importantly, surfactants and organic molecules in real samples often prevent successful use of the electrochemical sensors because they can competitively bind to the metal ions and foul the electrodes. To minimize fouling of electrodes, and competition for metals by proteins and surfactants, samples are typically pretreated to destroy organic complexants and organic surfactants present in the samples. One typical pretreatment method is UV digestion, which can take many hours. Wet ashing is another method that requires high acid and high temperatures up to 650° C. In other pretreatment approaches, to reduce the negative effects of proteins in blood, saliva, and urine, pretreatment includes acidifying a sample to release metals from proteins, followed by removal of the proteins via ultra-filtration. Even for a relatively clean matrix such as drinking water, wet ashing pretreatment can be necessary before using silver electrodes for analysis of Pb and Cd. Pretreatment methods can be time- and labor-consuming, inappropriate for field monitoring, and may contaminate samples by adding metals to the samples, e.g., from metal present in the reagents and equipment. Accordingly, new mercury-free sensors and methods are needed for real-time detection of metals in various sensor applications.

### SUMMARY OF THE INVENTION

In one aspect, the invention is an electrochemical sensor that determines a metal(s) in a fouling medium. The electrochemical sensor includes a preselected ratio of a porous sorbent mixed with a polymer applied as a film on a measurement surface of the sensor. The polymer acts as a binder that holds the sorbent on the sensor surface and further provides a hydrophilic environment that enables mass transport of metal(s) analytes into and out of the sorbent present on the modified sensor surface. The sorbent contains molecular functional (chelating) groups that can bind metal(s) present in sample media that also contain organics and other fouling components thus allowing the sorbent to accumulate and preconcentrate the metal(s) on the sensor or electrode surface. The sorbent also provides a strong support for the polymer matrix that minimizes degradation of the polymer layer over time. In addition, the selected polymer minimizes binding by fouling components present in the sample at the measurement surface that would normally interfere with the determination of a metal(s). The term “fouling components” as used herein means organic and/or biological components (e.g., proteins) in a metal-containing fluid or sample medium that interfere with accurate determination of the metal(s) analytes and result in rapid degradation of the electrode. The term “fouling” refers to the adherence (e.g., via adsorption) of these fouling components on the electrode surface rendering the surface less electroactive and results in a substantially reduced signal (e.g., electrical current). In biological fluids, fouling by biological components is termed biofouling.

In one embodiment, the porous sorbent is a self-assembled monolayer on a mesoporous support (SAMMS) material. The SAMMS material chemically coordinates and preconcentrates the metal(s). A preferred polymer is a fluoropolymer, but is not limited thereto.

In another aspect, the invention is also a system that includes an electrochemical sensor that is programmable for electrochemical measurement and detection. In one embodiment, the system includes a carrier reservoir; a control pump; a potentiostat; a sample valve interfaced to a computer that provides automation and programming capability for fluid and sample control; and an electrochemical cell that provides for preconcentration and measurement of a metal(s) in a sample.

In another aspect, the invention is also a method for using an electrochemical sensor for determination of a metal(s) in a fluid or sample medium that contains fouling components. The method includes the steps of: contacting an electrode or sensor surface with a preselected sample or fluid medium containing a metal(s) for a preselected period of time. The electrochemical sensor or electrode surface includes a film comprised of a preselected ratio of a porous sorbent and a polymer mixed together that forms the film precursor that is applied to a measurement surface of the sensor or electrode. The polymer acts as a binder that holds the sorbent on the sensor surface and further provides a hydrophilic porous environment that enables mass transport of metal analytes into and out of the sorbent present on the sensor surface (e.g., modified electrode surface). The sorbent chemically coordinates and preconcentrates the metal(s) collected from the fluid or sample medium. The polymer minimizes binding of fouling components present in the fluid or sample medium that can interfere with determination of the metal(s) and that rapidly degrade the sensor. Fouling media include, but are not limited to, biological fluids including, e.g., blood; saliva; urine; combinations of these fluids, and other metal-containing biological fluids. Fouling components in these fluids include, e.g., proteins, organic molecules, inorganic molecules, immunologic components, biological degradation components (e.g., lignins, tannins, and like compounds); and combinations of these components. Other fouling media that include fouling components include river water, sea water and groundwater. In a preferred embodiment, the sorbent is a self-assembled monolayer on a mesoporous support (SAMMS) material. SAMMS materials include, but are not limited to, e.g., AcPhos-Acid SAMMS materials; Thiol SAMMS materials; IDAA-SAMMS materials; TSA-SAMMS materials, and combinations these SAMMS materials. The SAMMS component in the film includes terminal functional groups that coordinate or chelate metal ions in the fouling medium, preconcentrating them on the electrode surface. In various embodiments, the chelating groups in the SAMMS material can include a sulfonic acid (SO₃H) group, a carboxylic acid (COOH) group, a phosphonic acid group, a thiol group, or other synergistic chelating groups including, but not limited to, e.g., amide carbonyl groups, phosphoryl groups, phosphine groups, amine groups, and combinations of these acid and synergistic chelating groups. The term “synergistic” refers to the ability of one ligand to enhance or affect the binding ability of another ligand to a target metal ion. Other porous sorbents suitable for use include, but are not limited to, functionalized mesoporous carbon sorbents, functionalized activated carbon sorbents, and porous metal oxide sorbents. Preferred polymers include fluoropolymers that provide the sensor surface with preselected properties including, but not limited to, e.g., wettability, chemical resistance; chemical stability; thermal stability; and combinations of these properties, but are not limited thereto. In one embodiment, the fluoropolymer is a tetrafluorethylene-containing fluoropolymer also known as NAFION®. In another embodiment, the fluoropolymer is TEFLON®. In another embodiment, the fluoropolymer component provides the film with a chemical stability over a pH range of from pH 1 to about pH=9. In a preferred embodiment, the composite film is prepared using a film precursor that includes a 5-10% (w/v) mixture of solid SAMMS sorbent in a NAFION solution (e.g., containing 5% NAFION solid by weight in a mixture of water and alcohols as solvents). The composite film is prepared by applying the film precursor mixture to a sensor surface and drying (e.g., air-drying) the composite mixture to remove solvents thus affixing the film. In one embodiment, the cured film on the sensor surface includes 70% SAMMS and 30% NAFION by weight. In another embodiment, the cured film on the sensor surface includes 50% SAMMS and 50% NAFION by weight. The metal(s) is preconcentrated in the sample medium by the SAMMS sorbent in the film. Since SAMMS is not conductive, after the metal(s) is preconcentrated by the SAMMS sorbent, the metal(s) is released from the SAMMS sorbent component in the film to the conductive component of the electrode. Release of the metal(s) is accomplished by immersing the electrode in a clean acid medium. The released metal(s) is simultaneously chemically reduced by applying a negative potential to the electrode, which prevents the metal(s) from moving into the bulk solution and leaving the electrode surface. In a subsequent step, the reduced metal(s) [e.g., elemental metal(s)] is oxidized which yields an electrical current at a preselected electrical potential that allows for determination of the metal(s) concentration in the sample or fluid medium. The metal(s) is released from the SAMMS material and reduced on a conductive portion of the selected electrode or sensor (e.g., a glassy-carbon or screen-printed carbon electrode). The SAMMS component of the composite film is configured to release the metal(s) in the same (or different) acid solution with an applied potential, which provides an electrical current at a known voltage that is specific to each metal. The peak location (voltage) is used to identify each metal(s). The signal current is proportional to the metal concentration in the original sample medium.

In various embodiments, the electrochemical sensor can include: screen-printed electrodes; glassy carbon (GC) electrodes; metal electrodes; electrochemical devices; metal analyzers; including combinations of these components. The sensor or electrode includes a measurement surface that detects an electrical signal upon release of a metal(s) from the sensor film. In one embodiment, the electrochemical sensor includes a screen-printed electrode. In another embodiment, the electrochemical sensor includes a glassy carbon (GC) electrode. In various other embodiments, the electrodes can include a preselected metal, e.g., a precious metal (e.g., gold, platinum, and like metals). In another embodiment, the electrochemical sensor includes an electrochemical cell, e.g., a wall-jet, flow-onto electrochemical cell with a built-in glassy carbon electrode as a working electrode.

In one embodiment, the sensor provides a detection limit for a metal(s) at or below about 1 ppb using a preconcentration time of up to 3 minutes. Preconcentration times are not limited. Increasing the preconcentration time improves detection limits.

In various embodiments, the electrochemical sensor is configured to determine metals present in a fluid or sample medium selected from the Group 3 to Group 16 elements of the Periodic Table. In one embodiment, the sensor provides a determination of metal(s) that include: Pb, Cu, Hg, Cd, and combinations of these metals. In another embodiment, the sensor provides a determination of metal(s) that include: Ag, TI, Eu, U, and combinations of these metals.

While the present invention is described herein with reference to preferred embodiments thereof, it should be understood that the invention is not limited thereto, and various alternatives in form and detail may be made therein without departing from the scope of the invention. A more complete appreciation of the invention will be readily obtained by reference to the following description of the accompanying drawings in which like numerals in different figures represent the same structures or elements.

### BRIEF DESCRIPTION OF THE DRAWINGS

FIG. 1 presents a proposed structure of an exemplary perfluorinated ionomer used in conjunction with the invention.

FIG. 2 presents a proposed structure of exemplary self-assembled monolayer on a mesoporous support (SAMMS™) material used in conjunction with the invention.

FIGS. 3a-3b show exemplary SAMMS™-NAFION® electrochemical sensors, according to two embodiments of the invention.

FIGS. 4a-4f show voltammograms from cadmium (Cd) measurements obtained with the SAMMS™-NAFION® electrode in various matrices, according to the invention.

FIG. 5 show response voltammograms from cadmium (Cd) measurements obtained with the SAMMS™-NAFION® electrode as a function of pH in filtered river water.

FIG. 6 shows response curves obtained from measurement of samples containing Cd and Pb in 0.01 M CH3COONa both in the presence and absence of bovine serum albumin (BSA).

FIGS. 7a-7d show response curves from cadmium (Cd) measurements obtained with the SAMMS™-NAFION® electrode as a function of increasing preconcentration time in various matrices.

FIGS. 8a-8b show response curves from cadmium (Cd) measurements obtained with the SAMMS™-NAFION® electrode in various matrices as a function of metal concentration.

FIG. 9 show response curves from lead (Pb) measurements obtained with the SAMMS™-NAFION® electrode at low concentrations in various natural water matrices.

FIG. 10 compares response curves obtained from samples containing cadmium (Cd), lead (Pb), and copper (Cu) metals measured with the SAMMS™-NAFION® electrode in various natural water matrices.

FIG. 11 shows the response curve for cadmium (Cd) metal in human urine obtained using the SAMMS™-NAFION® electrode.

FIG. 12 shows response curves obtained for cadmium (Cd) metal in filtered river water using the SAMMS™-NAFION® electrode as a function of increasing thallium (TI) concentration.

### DETAILED DESCRIPTION OF THE INVENTION

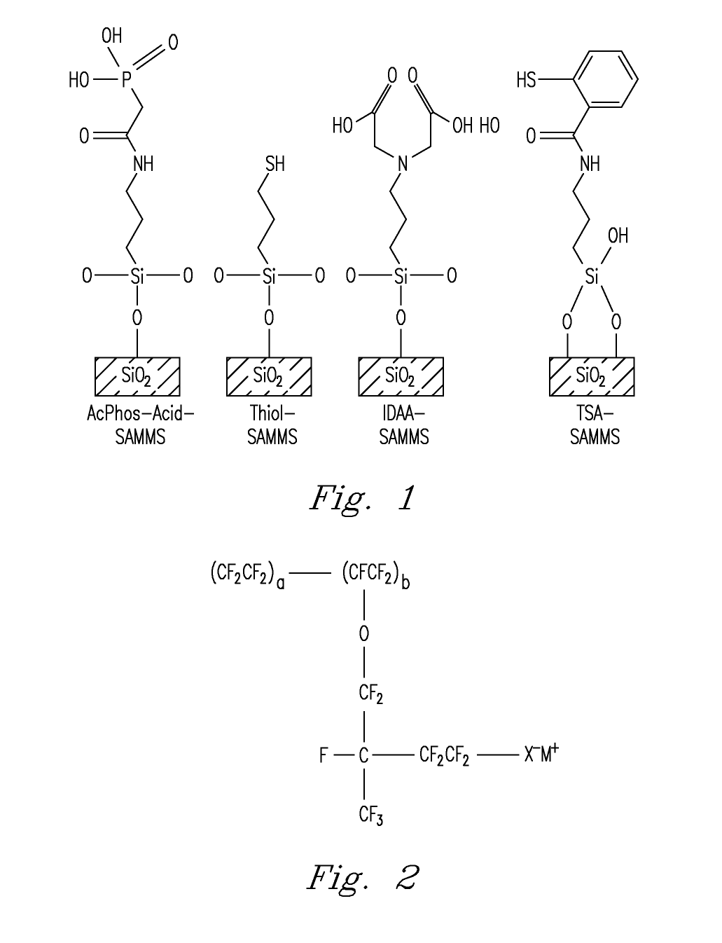

A mercury-free electrochemical sensor is described that includes a film (coating) comprised of a preselected ratio of a porous sorbent and a polymer of a preselected thickness. A film precursor mixture is prepared by mixing the sorbent in a liquid form of the polymer that serves as a binder that allows the mixture to be applied to the desired sensor or electrode surface. The film is formed by drying the mixture as described further herein. While a preferred embodiment is described hereafter, the invention is not limited thereto. In a preferred embodiment, the sorbent is a self-assembled monolayer on a mesoporous support also known as SAMMS™(currently manufactured by Steward Advanced Materials, Inc., Chattanooga, Tenn., USA). FIG. 1 shows exemplary SAM MS™ materials suitable for use in conjunction with the invention, each having a predefined affinity for specific metal(s), but the invention is not limited thereto. For example, other porous sorbents suitable for use include, but are not limited to, functionalized mesoporous carbon sorbents, functionalized activated carbon sorbents, and porous metal oxide sorbents. In the preferred embodiment, SAMMS™ materials have an organized structure in which the organosilane molecules locate within pores of the mesoporous support, forming an ordered array of ligands that provide for selective capture and preconcentration of metal(s). SAMMS™ materials include, but are not limited to, e.g., acetamidephosphonic acid (AcPhos-Acid) SAMMS™; Thiol-SAMMS™; iminodiacetic acid (IDAA)-SAMMS™; and thiolsalicylamide (TSA)-SAMMS™. Thiol-SAMMS™ materials are selective for metals including, but not limited to, e.g., mercury (Hg), lead (Pb), cadmium (Cd), gold (Au), silver (Ag), thallium (TI), platinum (Pt) and palladium (Pd), including combinations of these metals. AcPhos-Acid SAMMS™ materials are selective for rare earth metals including, e.g. lanthanides and actinides, including combinations of these metals. Examples include, e.g., europium (Eu), and uranium (U). IDAA-SAMMS™ materials are selective for first-row transition metals including combinations of these transition metals. Other metal-selective SAMMS materials may also be used including those with salicylamide and glycinyl urea groups. While the invention is described herein with reference to these listed SAMMS™ metal-selective sorbents, the invention is not limited thereto. All metal-selective SAMMS™ sorbents can be used without limitation. No limitations are intended.

In the preferred embodiment, a preferred and exemplary polymer is a perfluorinated polymer, i.e., a sulfonated tetrafluorethylene copolymer also known as NAFION® (DuPont de Nemours Inc., Wilmington, Del., USA). In a preferred mode, the NAFION® polymer is introduced in liquid form as a dispersion of NAFION® in a mixture of water and alcohols (e.g., LIQUION™ products) which are available commercially (ion Power, Inc., New Castle, Del., USA) as 5% and 15% by weight solids, low and high equivalent weight (EW) NAFION® polymers. FIG. 2 shows a proposed chemical structure of the exemplary perfluorinated polymer used in conjunction with the invention, but is not limited thereto. NAFION® is a unique ion-binding polymer (ionomer). NAFION® is structurally complex. NAFION® contains small proportions of sulfonic (SO₃H) acid groups or carboxylic acid (COOH) groups. These functional groups are denoted generically by an (X) in the figure. These functional groups act as ion-exchange sites on the perfluorinated polymer backbone, which give this ionomer unique equilibrium ion selectivities and ion transport properties. Due to electrostatic interactions, these ionic groups tend to aggregate to form tightly packed clusters. In the figure, (M) represents a preselected metal in the neutralized form, or alternatively the ligand in protonated (H+, or acidic) form (i.e., no metal attached). NAFION® is an exemplary and representative compound from the class of fluorinated (or highly fluorinated) polymers tested in conjunction with the invention, but is not limited thereto. The exemplary co-polymer is used as a binder for the metal-selective sorbent, e.g., SAMMS™ materials. NAFION® also influences the wettability of the sensor surface, an important consideration for a sensor interface. NAFION® is not electroactive and thus does not interfere with operation of the electrode. NAFION® also has selective permeability (i.e., preferential permeation of certain ionic species through the porous film) and molecular size selectivity properties, which properties permit metal(s) to move freely to the sensor surface in the presence of fouling and competing organic components. NAFION® also has a characteristic viscosity in liquid form, e.g., in a selected solvent. For example, in liquid form when mixed with a SAMMS™ sorbent, NAFION® binds the SAMMS™ particles together which aides integration with the electrode surface, e.g., introduction to surfaces of the sensor or electrode; provides exchange (coordination) sites for complexation and ion-binding; and provides a non-stick surface that inhibits fouling, e.g., by biological fluids and components including, e.g., proteins present in blood and urine. In addition, NAFION® is thermally and chemically stable; is mechanically strong; has useful ionic properties which may play a role in the metal binding process, and is insoluble in water. NAFION®'s unique ionic properties are a result of incorporating perfluorovinyl ether groups terminated with sulfonate groups onto a tetrafluoroethylene backbone. While the invention is described with reference to the NAFION® polymer, the invention is not limited thereto. For example, other fluorinated polymers that provide similar or other unique properties can also be used including, e.g., TEFLON® (DuPont de Nemours Inc., Wilmington, Del., USA). Thus, the invention is not intended to be limited to the exemplary polymer only. Exemplary electrochemical sensor platforms that incorporate SAMMS™-NAFION® composite materials (e.g., as a measurement surface, have been tested. While reference is made to these exemplary configurations, the invention is not limited thereto. All electrochemical sensors, devices, and electrodes that incorporate the composite film are within the scope of the invention. Thus, no limitations are intended.

### Electromechmical Sensor Platforms

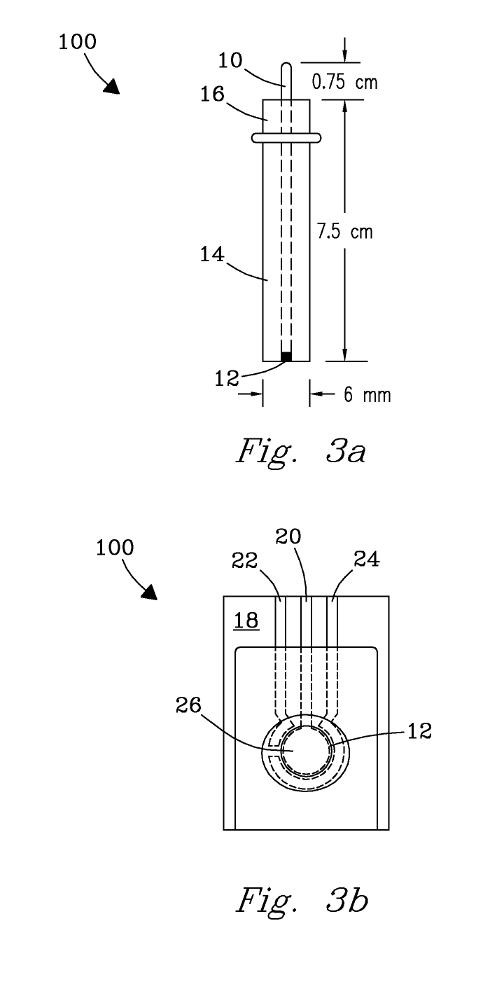

FIG. 3a shows an electrochemical sensor 100 of a glassy-carbon electrode design, according to an embodiment of the invention. In the instant embodiment, a glassy carbon rod 10 is used as a current collector. The electrode further employs a SAMMS™-NAFION® film 12 of the invention located on the measurement (conducting) surface of the electrode. The film is in contact with the fluid or sample medium that contains the metal(s) to be determined. Thickness of the SAMMS™-NAFION® composite film is not limited. Thickness is variable and depends on the size of the sorbent particles used in the film. Minimum thickness of the film is estimated to be about 0.2 mm, but is not intended to be a limiting parameter. A film precursor mixture that includes the selected ratio of sorbent (e.g., SAMMS™) and polymer (e.g., NAFION® polymer) components is mixed and the mixture is applied to the surface of the electrode or measurement surface. Techniques for applying include, but are not limited to, e.g., dip-coating, drop-coating, spin-coating, spray-coating, and like coating methods, and other application methods including, e.g., screen-printing and masking. No limitations are intended. For example, spin coating, can be used for large-scale manufacturing and precise production of the electrodes. Greater inter-electrode reproducibility will be expected by adhering to a precise manufacturing protocol for each electrode surface. As will be understood by those of skill in the art, thickness of the composite film can be varied or increased, e.g., by 1) applying multiple layers of the film on the electrode or sensor surface, 2) increasing the SAMMS™ to NAFION® ratio, or 3) increasing the particle size of the SAMMS™ sorbent. In a preferred embodiment, the SAMMS™ component in the composite film comprised Thiol-SAMMS™, which was used to preconcentrate metals in a sample medium for electrochemical determination of the metals. As described herein, the NAFION® component in the composite film precursor mixture is used as a binder for the SAMMS™ component. The NAFION® component of the sensor also modifies the surface wettability properties of the sensor, which minimizes biofouling of the electrode surface by inhibiting binding of various biofouling components in biological samples at the electrode surface. Biofouling is also minimized by the size-exclusion and perm-selective properties of the porous SAMMS™-NAFION® composite film as described herein. The instant invention thus has the advantage of providing consistent reproducible metal determination results in biological samples. The electrode was tested as described hereafter. Electrochemical signals are proportional to the concentration of metals in the samples. The instant sensor design and method are suitable for quantitative analysis of metals in both biological and non-biological samples. In exemplary tests, described hereafter, the sensor detected 0.5 ppb of lead (Pb) and 2.5 ppb of cadmium (Cd) in river water (RV), groundwater (GW), and seawater (SW) without any sample pretreatment with a minimal amount of preconcentration time (˜few minutes). The sensor also detected 2.5 ppb of Cd, Pb, and copper (Cu) simultaneously, but is not limited thereto.

FIG. 3b shows another exemplary electrochemical sensor 100 of a screen-printed carbon electrode or test-strip design, according to an embodiment of the invention. Sensor 100 includes a substrate 18 or support 18 that further includes, e.g., three (screen-printed) electrodes, a working electrode 20 used to measure current (potential) for metal(s) released from the SAMMS™ component in the SAMMS™-NAFION® composite film during electrochemical (voltammetric) analysis; a reference electrode 22 that provides an electrical potential against which all other potentials for sample metal(s) are measured; and a counter electrode 24 that prevents electrical current from flowing incorrectly through reference electrode 22. In the instant design, working electrode 20 includes a sample loading zone 26. Sample loading zone 26 is coated with SAMMS™-NAFION® composite film 12 that includes a preselected ratio of SAMMS™ sorbent and NAFION® polymer. The film provides for the preconcentration and measurement of metal(s) in the sample medium. Thickness of the composite film is not limited. At the start of the sample metal(s) determination, a liquid sample aliquot (e.g., 100 μL) containing a target metal(s) is applied to sample loading zone 26. Fluid and metal(s) migrate under piezoelectric forces through the SAMMS™-NAFION® composite film 12 in sample loading zone 26. Metal(s) in the sample liquid are retained by the SAMMS sorbent in the SAMMS™-NAFION® composite film 12. The loading zone 26 surface may optionally be rinsed with, e.g., water to remove any unbound metal(s) and sample liquid. Metal(s) preconcentrated in the SAMMS component of the composite film are simultaneously released by addition of an aliquot (e.g., 30 uL) of acid (e.g., 0.3M to 0.5M HCl) to sample loading zone 26, and reduced by applying a negative potential to working electrode 20, followed by voltammetric detection in concert with an electrochemical detector (not shown). This sensor design can be constructed for disposal following use. The electrochemical sensor of the instant design can also be configured to insert into, e.g., a detection instrument, e.g., a hand-held amperometric or electrochemical reader that displays results for a rapid determination of metals in a biological or other biofouling sample. The instant sensor design and method are suitable, e.g., for screening and/or quantitative analysis of metal(s) in both biological and non-biological samples. Test strip screening, for example, can be used to rapidly assess whether a metal(s) in a fluid or a biological sample exceeds a preset threshold value or concentration that then warrants a more comprehensive patient evaluation or further sample analysis. Electrochemical signals are proportional to the concentration of metals in the samples. The sensor is disposable following use.

### Exemplary Operation Conditions for SAMMS™-NAFION® Sensors

Exemplary operating conditions for the SAMMS™-NAFION® sensors are listed in TABLE 1.

TABLE 1
Typical operating conditions of Thiol-SAMMS ™-NAFION ®
sensors.

| Parameters | Conditions |
|---|---|
| Electrode | Glassy-Carbon; coated with 10 w/v % |
| | Thiol-SAMMS ™-NAFION ® mixture |
| Sample | 8 mL of samples containing, e.g., Cd, Pb, and Cu |
| Preconcentration | 3 minutes in stirred sample at open circuit |
| Electrolysis | −0.95 V, 60 s in 8 mL of 0.1 M HCl |
| Detection | scan from −0.95 V to −0.30 V in same acid |
| SWV parameters | Amplitude: 25 mV, increment: 5 mV, freq: 50 Hz |

The Thiol-SAMMS™ component provides superior sorption properties for soft metal ions compared to commercial resins (e.g., GT-73). Distribution coefficients for the Thiol-SAMMS™ component to Cd, Pb, and Cu in acetate solutions, natural waters, and human urine are summarized in TABLE 2.

TABLE 2
Distribution coefficients (Kd)^{a} of Cd, Pb, and Cu in various matrices.

| | | Cd | Pb | Cu |
|---|---|---|---|---|
| Matrices^{b} | pH | (mL/g) | (mL/g) | (mL/g) |
| Columbia River water | 7.84 | 8700000 | 3100000 | 1300000 |
| Hanford ground water | 8.13 | 16000000 | 6000000 | 1400000 |
| Sequim Bay seawater | 7.65 | 1100000 | 1400000 | 1700000 |
| 0.01 M CH₃COONa | 6.64 | 4000000 | 1800000 | 1300000 |
| Human urine | 5.80 | 5100 | NA | NA |

^{a}Distribution coefficients (Kd) were measured at a liquid-to-sorbent (L/S) ratio (i.e., total sample volume to sorbent) of 5000 mL/g. Initial metal ion concentrations were 100 ppb (each) in triplicate, except for the human urine sample where the L/S ratio was 1000 mL/g, and the initial Cd concentration was 50 ppb.
^{b}Natural water samples were filtered through a 0.45 micron filter before use.

The distribution coefficient (K_{d}) is a measurement of the binding affinity and is a mass-weighted partition coefficient between the supernatant and SAMMS™ component. The greater the value of (K_{d}), the more effective the sorbent material is at capturing and holding the target metal(s). In general, sorbents with (K_{d}) values of 10²-10³ mL/g are good and those with (K_{d}) above 10⁴ mL/g are outstanding. From the listed (K_{d}) values, Thiol-SAMMS™ is an outstanding sorbent for Cd, Pb, and Cu in various matrices and is also a good sorbent for Cd in human urine.

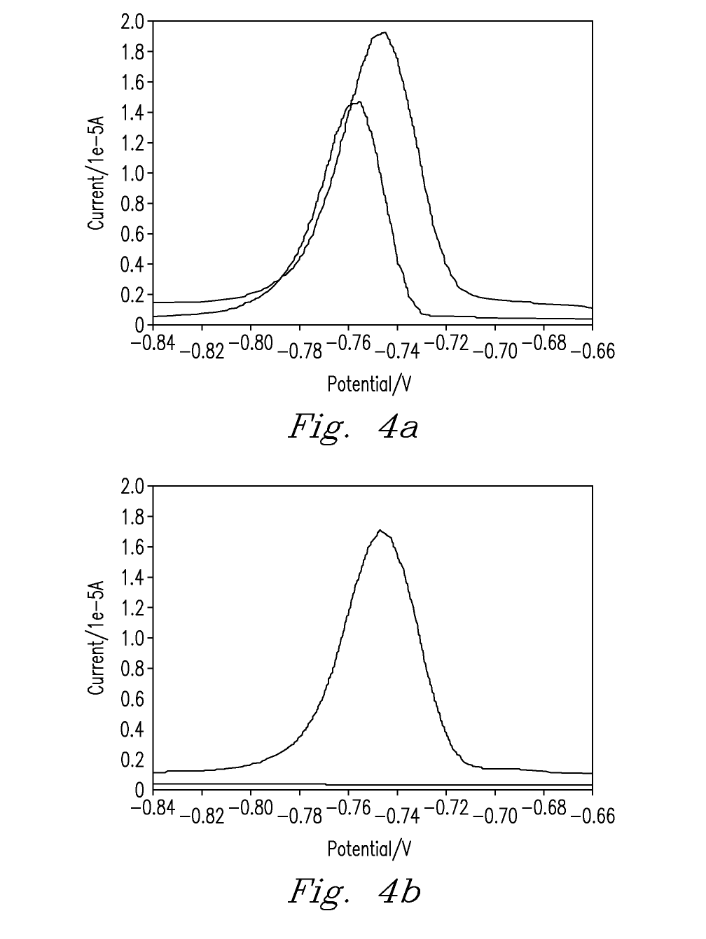

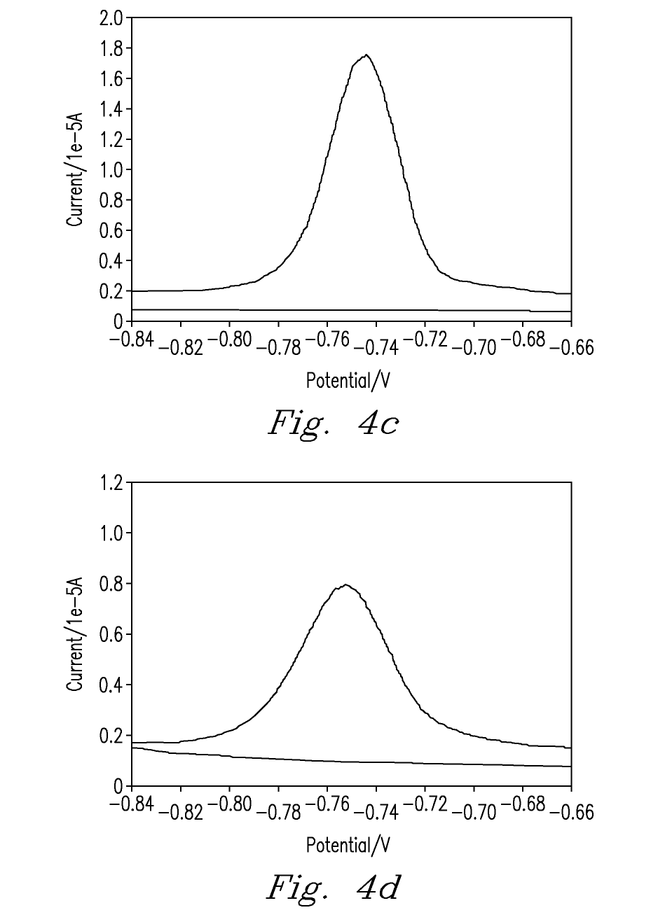

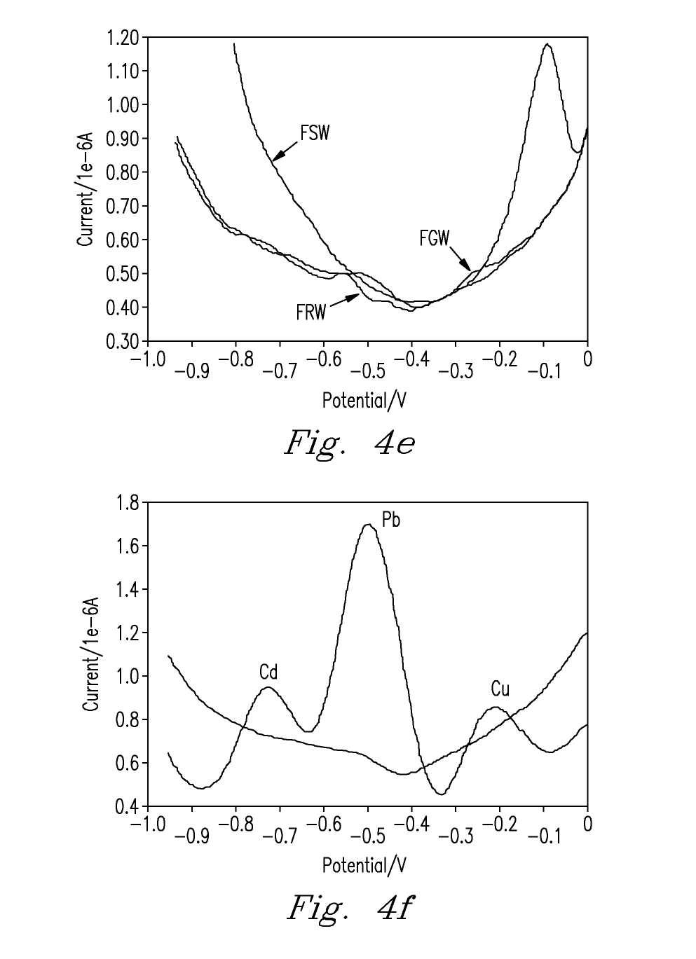

FIGS. 4a-4f compare measurement signals for 25 ppb Cd measured using the Thiol-SAMMS™-NAFION® sensors (thick lines) compared to controls measured using a NAFION® coated electrode (thin lines) after 3 min preconcentration in: 0.01 M CH3COONa (NaAc) (FIG. 4a); filtered ground water (FGW) (FIG. 4b); filtered river water (FRW) (FIG. 4c); filtered seawater water (FSW) (FIG. 4d); magnification of the Cd voltammograms at the NAFION®-coated electrode (FIG. 4e); and voltammograms of 10 ppb Cd/Pb/Cu in NaAc measured with the two electrodes (FIG. 4f). FIG. 4a shows that after 3 minutes of preconcentration, the SAMMS™-NAFION® sensor could detect 25 ppb of Cd in acetate solution and natural waters, while the control sensor could detect Cd only in acetate solution but not in natural waters (FIGS. 4b-4e), where Cd ions can be bound to various constituents. The Thiol-SAMMS™ component in the composite electrodes also increases detection sensitivity for metal ions. For example, the SAMMS™-NAFION® sensor could detect 2.5 ppb of Cd, Pb, and Cu in acetate solution after 3 minutes of preconcentration, while the control electrode (without SAMMS™) could not detect 10 ppb of Cd, Pb, and Cu in the same solution (FIG. 4f). Results clearly show the advantages introduced to the sensor by employing Thiol-SAMMS™ for metal preconcentration at the electrode electrochemical surface of the sensor.

### Reliability and Reproducibility

The perfluorinated backbone chain of NAFION® is noted for its chemical and physical stability [see, e.g., Electrochim. Acta, 46 (2001) 1559-1563]. With a completely calcined silica support structure and surface functionalized with covalent crosslinked ligands, SAMMS™ component materials are very stable. As a result, the NAFION® and SAMMS™ composite mixtures provide a porous film with good mechanical and chemical stability resulting in robust, stable and selective electrodes.

### Service Life

The SAMMS™-NAFION® electrodes and sensors have a long service life. They also provide excellent single and inter-electrode reproducibility (5% RSD). Further, SAMMS™-NAFION® electrodes are not fouled in samples containing proteins (e.g., albumin), and they successfully detect metals, e.g., in human urine. Confounding factors that can potentially affect metal detection including, e.g., pH effects, transport resistance of metal ions, and detection interferences were not observed to affect the SAMMS™-NAFION® sensors. SAMMS™-NAFION® composite sensors also reliably detect low metal concentration ranges without sample pretreatment and fouling, and have the potential to become a next generation metal analyzer for environmental and bio-monitoring of toxic metals.

### Stripping Voltammetry

Stripping voltammetric detection of metal ions at the SAMMS™-NAFION® electrodes is a 3-step process; (1) preconcentration of metals in sample solutions at open circuit by exploiting the binding affinity between preselected functional groups (e.g., thiol groups; phosphonic acid groups, etc.) and target metals, (2) simultaneous desorption and cathodic electrolysis in an acid solution, and (3) subsequent detection by an anodic stripping voltammetry technique in the same acid solution. Cleaning can be performed in the same acid solution and in some cases is not required since stripped metal ions do not re-adsorb onto the SAMMS™ component in acid solutions.

### Effect of Solution pH

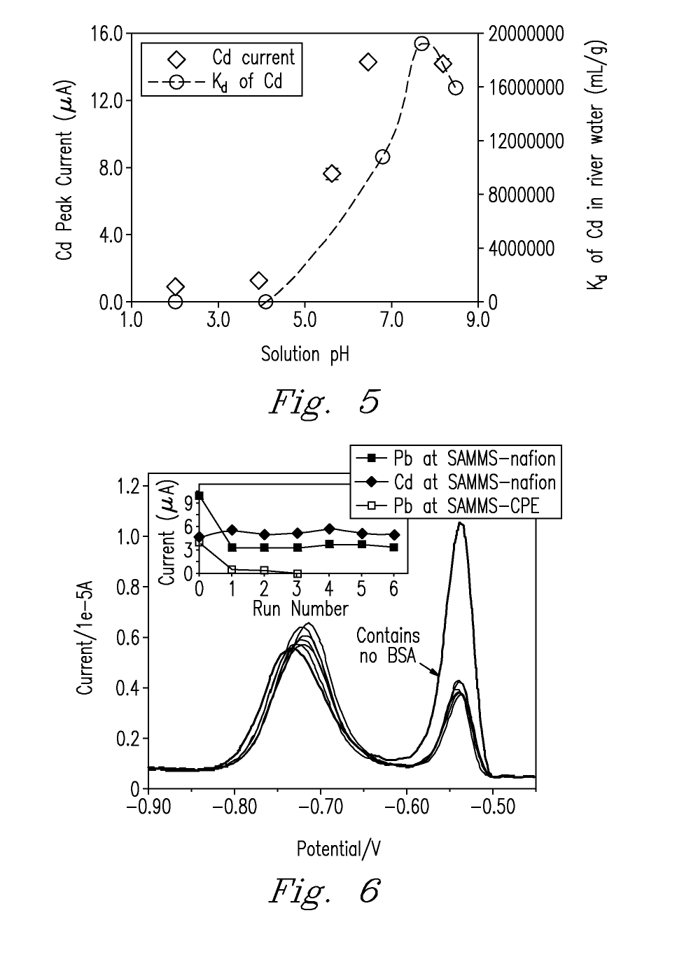

Solution pH has profound effects on preconcentration of metal ions at the Thiol-SAMMS™-NAFION® electrodes, which rely on the binding affinity between the metal ions and the thiol groups on SAMMS™. FIG. 5 is a voltammogram that shows the effect of solution pH on response signal in a 25 ppb Cd solution measured with the Thiol-SAMMS™-NAFION® electrode in pH-adjusted filtered river. In the figure, a second Y-axis shows the distribution coefficient (K_{d}) of Cd on Thiol-SAMMS™, also measured in pH-adjusted filtered river water (initial Cd concentration of 100 ppb; L/S of 5000 mL/g SAMMS™). In the figure, the voltammetric signal of Cd depends on the affinity of Thiol-SAMMS™ component immobilized on the electrode surface that captures the Cd metal. The ability to capture is further a function of pH. In the pH range from about 0 to 4, (K_{d}) values are small, and virtually no signal for Cd is observed in that pH range. As pH increases from about 4 to 8, (K_{d}) values increase significantly. This corresponds to a substantial increase in Cd signal in the pH range from about pH 4 to pH 6.5. Signal levels off in the range from pH 6.5 to about pH 8.2. Above a pH of 8, signal again drops off. For the composite sensor, optimal pH for Cd measurements was found to be in the range of 6 to 8, which is also relevant to the pH of natural waters and urine. The shift in the effect of pH on the sensor signal for measured Cd as compared to the observed (K_{d}) may be primarily a local pH issue, e.g., thiol ligands buried in the NAFION® matrix may experience a pH slightly higher than the pH observed for the bulk solution recorded as the (K_{d}) values were measured.

### Antifouling Properties of SAMMS™-NAFION® Electrodes in Protein-Rich Samples

SAMMS™-NAFION® electrodes have excellent antifouling properties owing to the ability of the NAFION® component in the composite film to exclude molecules of large size (e.g., MW>200). FIG. 6 shows electrochemical responses obtained from measurement of samples containing 25 ppb of Cd and Pb in 0.01 M CH3COONa in the absence of bovine serum albumin (BSA) and for 6 consecutive runs after the addition of 20 mg/L of BSA with a 3 minute preconcentration time. Addition of BSA does not affect the Cd signal but reduces the Pb signal by as much as 65%, suggesting there is at least some competition between BSA and the Thiol-SAMMS™ component for Pb. When signals are reduced due to known matrix effects, metal(s) can be accurately determined using, e.g., standard addition methods, which compensate for matrix effects. Nevertheless, Pb and Cd peaks remain stable in consecutive measurements in samples containing the biofouling component BSA, demonstrating the antifouling properties of the SAMMS™-NAFION® composite electrode. In a control experiment in the same solution, a carbon paste electrode (CPE) modified with 10 wt % Thiol-SAMMS™ (but no NAFION® polymer) was fouled after a first measurement, which prevented the electrode from measuring metals in subsequent samples. Results showed a six-fold decrease in signal measured for the 25 ppb Pb, with no signal measured for 25 ppb Cd even after 5 minutes of preconcentration (inset) compared to results obtained for the electrode containing the Thiol-SAMMS™-NAFION® composite film. Results clearly demonstrate advantages provided by the NAFION® component in the SAMMS™-NAFION® composite film that minimizes fouling, e.g., biofouling. The following sections describe use of Thiol-SAMMS™-NAFION® sensors for metal detections in natural waters and human urine in order to take advantage of the combined advantages and properties of both Thiol-SAMMS™ and NAFION® in the composite material of the SAMMS™-NAFION® electrode.

### Sensor Response as a Function of Metal Concentration

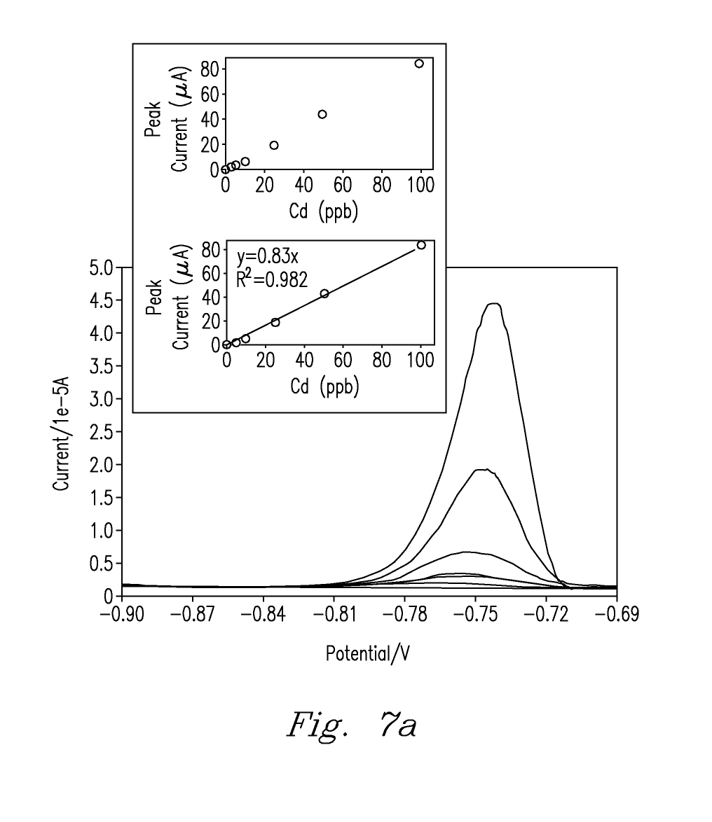

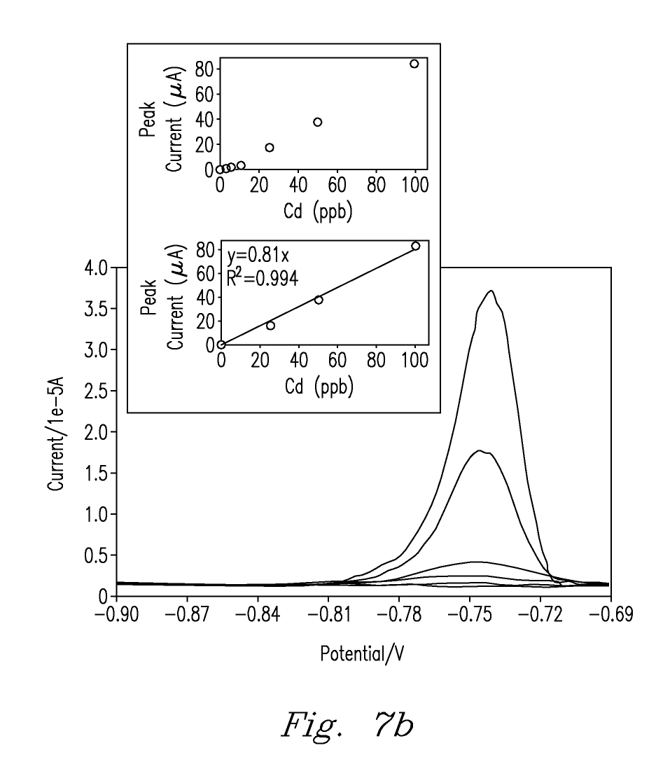

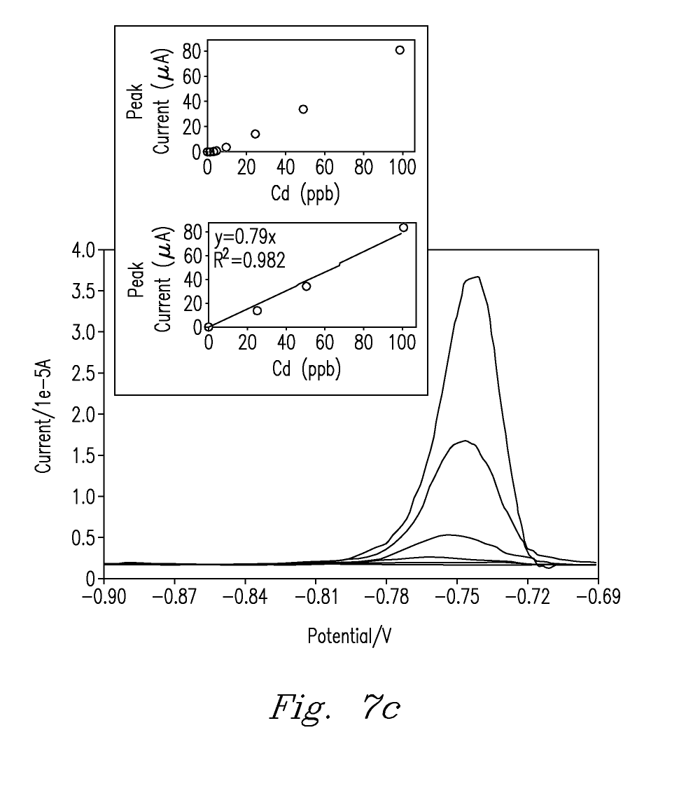

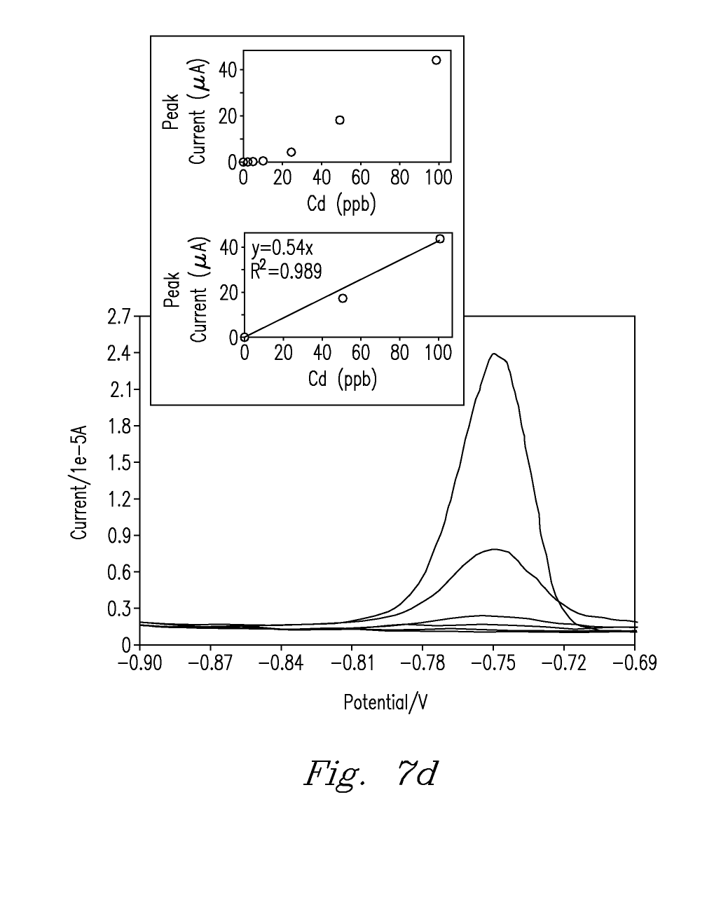

FIGS. 7a-7d present voltammograms for Cd measured with the Thiol-SAMMS™-NAFION® electrode in various matrices including, but not limited to, e.g., 0.01 M CH3COONa sodium acetate buffer (NaAc) (FIG. 7a), filtered ground water (FGW) (FIG. 7b), filtered river water (FRW) (FIG. 7c), and filtered sea water (FSW) (FIG. 7d). Insets graphs show a) response to increasing Cd concentration from 2.5 ppb to 100 ppb and b) calibration curves in linear range. In the figure, inset graphs show the whole data range and the linear data range. In all four matrices, Cd could be detected at 2.5 ppb after only 3 minutes of preconcentration, indicating excellent detection sensitivity. In acetate solution, a linear response was obtained for the whole concentration range. In natural waters, negative deviation from linear response at low concentration of Cd (e.g., 0-25 ppb) can be attributed to slow transport of metal ions (e.g., due to binding with anions or organic molecules in natural water) into the matrix of the NAFION® component; resistance to transport of metal ions into pores of the Thiol-SAMMS™ component in natural water is negligible. When the Cd concentration increases above 25 ppb, a linear response is achieved, which may be due to a greater concentration gradient of free Cd ions between the bulk solution and the NAFION® matrix.

### Sensor Response as a Function of Preconcentration Time

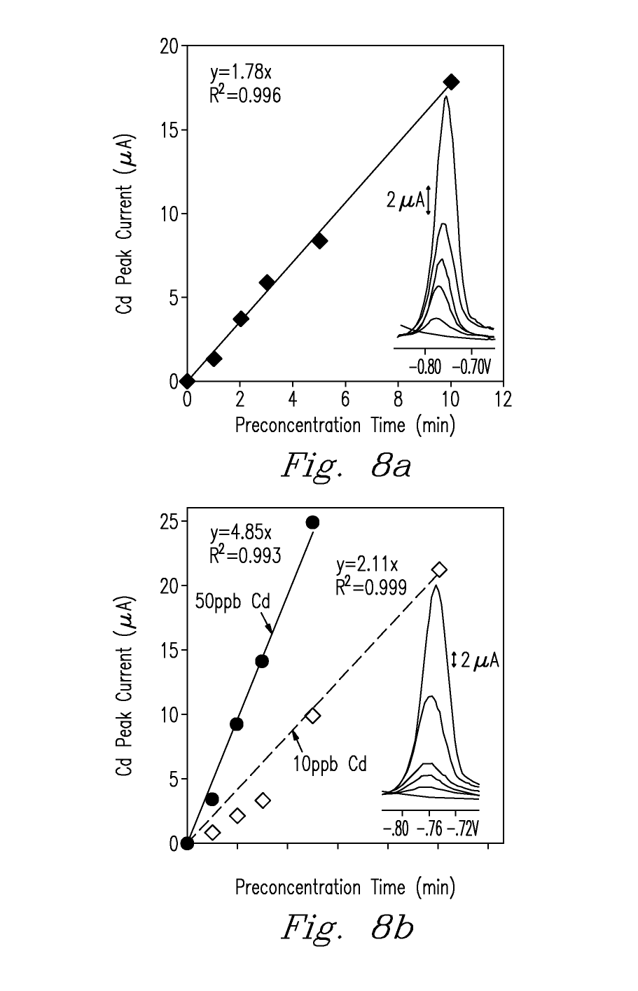

FIGS. 8a-8b compare response as a function of preconcentration time for Cd measured with the Thiol-SAMMS™-NAFION® electrode in: 10 ppb Cd in 0.01 M CH3COONa (NaAc) (FIG. 8a); and 10 ppb Cd and 50 ppb Cd in filtered river water (FRW) (FIG. 8b). Inset graphs show the corresponding voltammograms of 10 ppb Cd. Due to the rigid silica supports and appropriate pore structure, the THIOL-SAMMS™ component in the composite film provides a rapid metal sorption rate. The SAMMS™ component can remove over 99 wt % of 1 mg/L Pb from groundwater after 1 min of contact time. As a control, an EDTA-based resin (e.g., Chelex-100) and a thiol-based resin (e.g., GT-73) took greater than 10 minutes and 120 minutes, respectively, to remove over 96 wt % of Pb. The fast sorption rate of the Thiol-SAMMS™ component provides a short preconcentration time for the SAMMS™-NAFION® electrochemical sensor. In the sensor systems of the invention, 10 ppb of Cd is detected after only one minute of preconcentration time. And, Cd is detected near the EPA drinking water standard (5 ppb) [EPA, Consumer Fact Sheet on Cadmium: http://www.epa.gov/ogwdw/contaminants/dw_contamfs/cadmium.html]. In acetate solution, the linear response of 10 ppb Cd is obtained with from 0 to 10 minutes of preconcentration time. In filtered river water, at a concentration of 50 ppb Cd, a linear response was obtained with from 0 to 10 minutes of preconcentration, while at a concentration of 10 ppb Cd, it took over 5 minutes to achieve linear response. This deviation from linear response is attributed to resistance to transport into the NAFION® matrix of any Cd that may be bound to organic molecules. Thus, for detection in the low concentration range (e.g., below 25 ppb) in natural waters, a preconcentration time of 5 minutes or higher is recommended if a linear calibration curve is desired. The SAMMS™ component in the composite film of the electrochemical sensor also exhibits high affinity for Pb and Cu (in addition to Cd) as shown previously in TABLE 2 and can be used to preconcentrate many metals. The same principle found with Cd can be applied to other metal cations such as Pb, which suggests that the counter ions and organic molecules, and not the type of metal ions, are responsible for restricting transport of metal ions into the matrix of the NAFION® component.

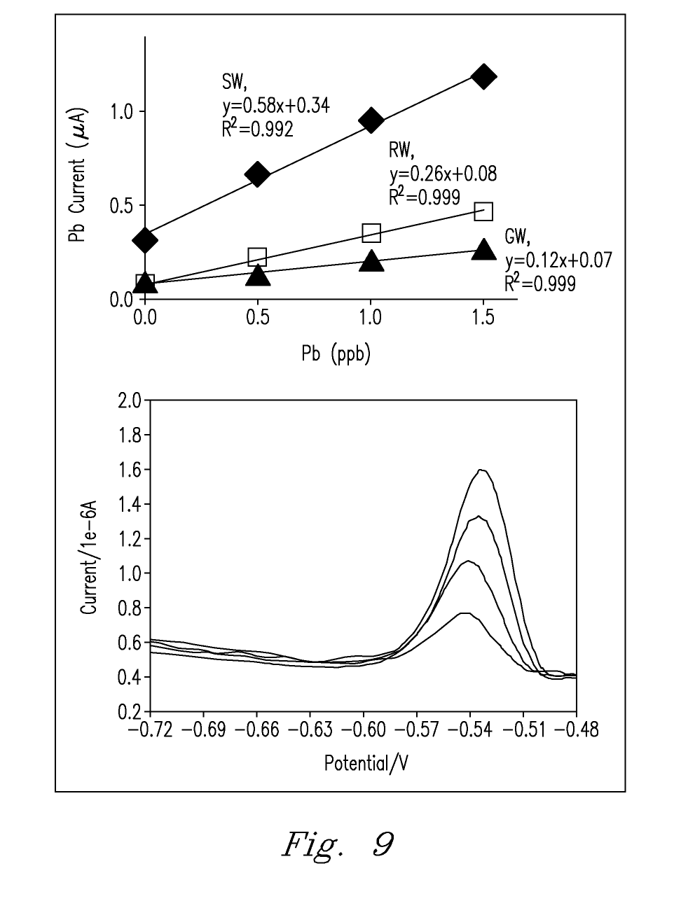

FIG. 9 compares responses of Pb measured using the SAMMS™-NAFION® electrode in various natural water matrices including, e.g., unfiltered river water, seawater, and groundwater after 6 min preconcentration at a concentration in the range from 0 to 1.5 ppb. The inset graph shows the linear response curve measured in unfiltered river water (RW) and groundwater (GW). At the same Pb concentration, signals were larger in seawater than in river water, and were the smallest in ground water, suggesting that organic substances present at relatively low levels in river water can negatively affect detection of Pb more than do the electrolytes which are present at high levels in seawater. However, results show the SAMMS™-NAFION® sensors are exceptionally sensitive for Pb and Cd detection. And, the Thiol-SAMMS™-NAFION® sensors can detect both Pb and Cd at low concentration ranges in un-pretreated natural waters, which previously has been extremely difficult to detect using conventional mercury-free electrodes.

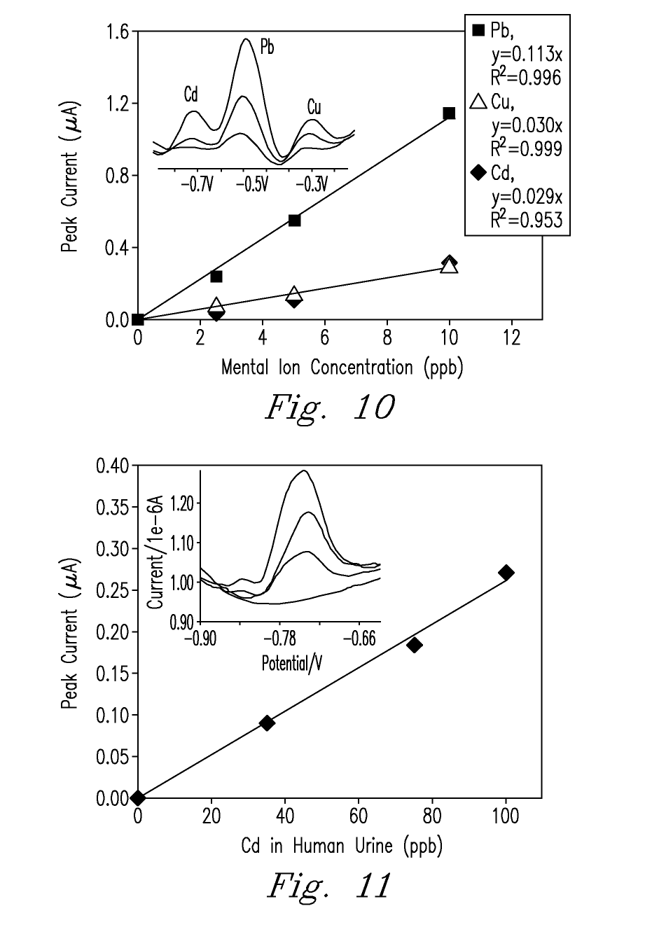

FIG. 10 shows response curves for multiple metals measured using the SAMMS™-NAFION® electrode in samples that included 0.01 M CH₃COOH (pH 7.12) after a 3 min preconcentration time. The inset graph shows voltammograms of (in the increasing order) of 2.5 ppb, 5 ppb, and 10 ppb (each) of Cd, Pb, and Cu. An EPA action level for metals present in public drinking water supplies is 15 ppb of Pb (EPA, Technical Fact Sheet on: LEAD, http://wwwepagov/OGWDW/dwh/t-ioc/leadhtml) and 5 ppb of Cd (EPA, Consumer Fact Sheet on: Cadmium, http://www.epa.gov/ogwdw/contaminants/dw_contamfs/cadmium.html). Results show that simultaneous detection of Cd, Pb, and Cu can be made at very low concentration ranges (0 to 10 ppb), relevant to trace level assay of metal ions using the SAMMS™-NAFION® electrode.

### Detection in Biological Fluids (Urine)

Urine is recognized as one of the best non-invasive matrices for biomonitoring of exposure to a broad range of xenobiotics, including toxic metals. However, urine is a complex matrix compared to natural water because it contains biofouling components that include proteins/peptides, electrolytes, and metabolic byproducts such as urea, uric acid, and creatinine. FIG. 11 shows the response measured using the SAMMS™-NAFION® electrode of Cd spiked in human urine (at a pH 5.8) after 3 minutes of preconcentration time. The inset graph shows the corresponding voltammograms. Results with the new SAMMS™-NAFION® composite electrode demonstrate that Cd in human urine can be detected, e.g., at concentrations as low as, e.g., 35 ppb, 75 ppb, 100 ppb, (recoveries of 99%, 95%, and 104% recovery, respectively). Results are attributed to the excellent metal affinity provided by the Thiol-SAMMS™ component and the antifouling properties provided by the NAFION® component. Detection of metal ions in urine has previously been problematic due to protein competition and electrode fouling as detailed, e.g., by Yantasee et al. [Anal. Bioanal. Chem., 387 (2007) 335-341].

### Detection Interference

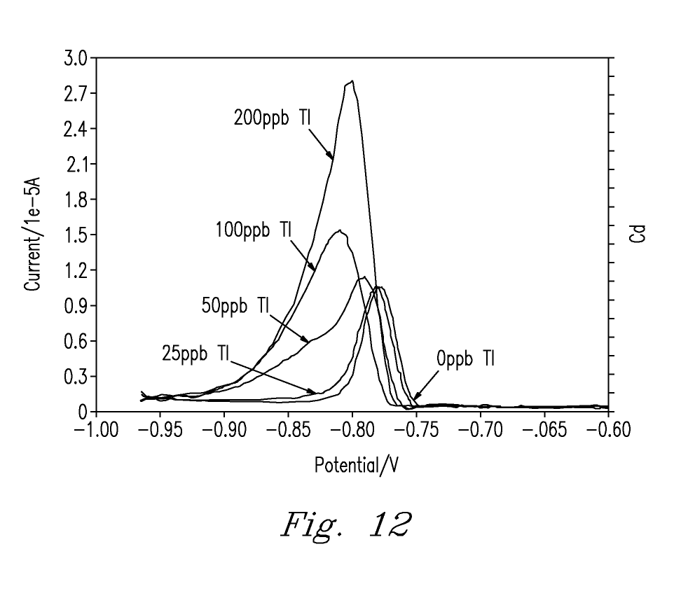

Thallium (TI) can cause detection interferences with Cd due to its close proximity to the Cd peak (e.g., at a slightly greater negative potential than Cd. The SAMMS™-NAFION® sensor of the invention offers advantages over electrodes known in the conventional art. FIG. 12 shows peak responses with the Thiol-SAMMS™-NAFION® electrode when TI is added to 25 ppb Cd in 0.01 M CH₃COONa at concentrations ranging from 0-200 ppb. In the figure, interference of TI and Cd signals in the acetate solution is not observed with the Thiol-SAMMS™-NAFION® electrode until the mass ratio of TI:Cd is greater than 2. This result is at least a factor of 25 greater than comparable interference results using a conventional silver electrode (mass ratio for TI:Cd of 0.08). The improved detection with the SAMMS™-NAFION® electrode is a result of a greater selectivity of Thiol-SAMMS™ for Cd compared with TI. The Thiol-SAMMS™ component has a K_{d} of 107 for Cd versus 102 for TI (in river water at a pH in the range from 6.8-8.1), and consequently captures Cd metal far more preferentially than TI. Results show no detection interferences for Cd and Pb in normal river and ground water samples. Further, signals for Cd and Pb do not overlap.

### EXAMPLE 1

### Samples and Reagents for Electrochemical Tests

Natural waters were Columbia River water (Richland, Wash.), Hanford groundwater (Richland, Wash.), and Sequim Bay seawater (Wash.). Samples were either filtered with 0.45-micron cellulose acetate membranes to remove particulates, or used as-received without filtration to show versatility of the sensors. In the study of pH effects only, pH of river water was adjusted with 0.1 M HNO₃ and 0.1 M NaOH, or used without pH adjustment. A human urine sample (pH 5.8) was purchased (Innovative Research, Inc., Novi, Mich., USA) and used without pretreatment after 50% dilution with DI water. Bovine serum albumin (BSA) was purchased (Aldrich Chemical Company, Inc., Milwaukee, Wis., USA). Metal ion solutions containing 1000 ppm Cd, Pb, and Cu in 1-2% HNO₃ were purchased (Aldrich Chemical Company, Inc., Milwaukee, Wis., USA) and diluted with DI water to 1 ppm prior to spiking.

### EXAMPLE 2

### Voltammetric Detection

Square wave voltammetry (SWV) experiments were performed with a handheld electrochemical detector (e.g., model CH11232A, CH Instruments, Inc., Austin, Tex., USA) equipped with a three electrode system: a custom-made working electrode, a platinum wire as auxiliary electrode, and Ag/AgCl in 3M NaCl as a reference electrode. Typical operating conditions are summarized in TABLE 2. The working electrode was prepared by dip coating a 3 mm diameter clean glassy carbon electrode (Bioanalytical Systems, Inc., IN, USA) in a mixture of 0.01 g Thiol-SAMMS™ and 0.1 mL of 5 wt % NAFION® solution (1100 equivalent weight NAFION® solid in a mixture of water and alcohols from Ion Power, Inc., DE, USA), which was sonicated for 1 min prior to the coating. The film was then air-dried at room temperature for about 1 hr prior to using the electrode. Preparation and surface characterization of Thiol-SAMMS™ are detailed, e.g., by Feng et al. in Science, 276 (1997) 923-926. All measurements were made at room temperature in ambient atmosphere. All solutions were used without degassing. The SWV was operated at a frequency of 50 Hz with a pulse amplitude of 25 mV and a potential step height of 5 mV. Electrolysis was performed at −0.95V for 60 sec in 0.1 M HCl. After a 5 sec quiet period, the potential was scanned from −0.95V to −0.3V and the peak of Cd, Pb, and Cu appeared at about −0.75V, −0.50V, and −0.21V respectively. Regeneration of the electrode was performed by applying 0.6V for 60 sec to the working electrode immersed in the stirred acid solution (same as the stripping solution).

### EXAMPLE 3

### Service Life and Reproducibility

Two SAMMS™-NAFION® composite electrodes were tested over a service period of 4 days. A total of 120 measurements were made with a first composite electrode. A total of 70 measurements were made with the second electrode. In these tests, although 0.1 M HCl was used as the electrolyte, electrode surfaces were found to be stable in higher acid concentration. Electrode surfaces are reliable and robust and were not renewed for any of the measurements. Reproducibility was also excellent. As an example, after immersing an electrode in 0.25 M HCl for 30 min., 60 min., 90 min., and 120 min., respectively, signals for 25 ppb Cd in 0.01 M sodium acetate solution measured with the same electrode were 1.0, 0.99, 1.00, and 0.91 (normalized with the average signal after 30 min of immersion). Reproducibility on a single electrode surface was determined as a relative standard deviation of 8 consecutive measurements of 25 ppb Cd in 0.05 M sodium acetate after 3 minutes of preconcentration, to be 5% (signals were 15.9, 15.3, 14.2, 15.9, 14.2, 15.8, 14.4, and 15.0 pA, respectively). Good inter-electrode reproducibility was demonstrated by measuring the ratios of signals of 25 ppb Cd in 0.05 M sodium acetate measured with four electrode surfaces, yielding 1.0, 1.0, 1.1, and 1.2 (normalized with an average signal from the first electrode surface).

### CONCLUSIONS

An electrochemical sensor that includes a functionalized silica and NAFION® composite has been described as a modifier for the electrode surface that provides a Hg-free electrode. The NAFION® component in the sensor acts as an antifouling binder and the Thiol-SAMMS™ component provides efficient metal preconcentration. Metal concentrations as low as 2.5 ppb of Cd and 0.5 ppb of Pb can be detected in natural waters after only 3 and 6 minutes of preconcentration time, respectively. Use of a NAFION® binder can potentially make conventional carbon paste and graphite ink obsolete because (1) it offers better accessibility to binding sites on the SAMMS™ sorbent that are embedded in the carbon paste or graphite ink matrix, resulting in higher detection sensitivity, (2) it offers antifouling properties that other binders do not, and (3) electrode preparation is simpler, yields a more reproducible surface, and can be mass-produced by, e.g., a spin-coating technique. The resulting SAMMS™-NAFION® composite electrodes are robust, reliable, and provide reproducible results. Thus, these electrodes have a great potential to be used in the development of the next-generation metal analyzers that are portable and field-deployable. While preferred embodiments have been described, the invention is not limited thereto. The appended claims are intended to cover all such changes and modifications as fall within the spirit and scope of the invention.

We claim:

1. An electrochemical sensor for determining a metal(s) in a sample medium, comprising:
a preselected ratio of a porous sorbent mixed with a polymer disposed on a measurement surface of said sensor;
said porous sorbent chemically coordinates and preconcentrates a metal(s) present in said sample medium;
said polymer minimizes binding of fouling components at said measurement surface when present in said sample medium.

2. The electrochemical sensor of claim 1, wherein said sample medium is a fluid including a material selected from the group consisting of: blood; plasma; saliva; urine; natural water, biological waste, and combinations thereof.

3. The electrochemical sensor of claim 1, wherein said fouling components in said medium are selected from the group consisting of: proteins, organic salts, inorganic salts, immunologic components, biological degradation products, waste products, and combinations thereof.

4. The electrochemical sensor of claim 1, wherein said porous sorbent is selected from the group consisting of: functionalized mesoporous carbon sorbents, functionalized activated carbon sorbents, porous metal oxide sorbents, and combinations thereof.

5. The electrochemical sensor of claim 1, wherein said porous sorbent is a self-assembled monolayer on a mesoporous support (SAMMS) material.

6. The electrochemical sensor of claim 5, wherein said (SAMMS) material is selected from the group consisting of: AcPhos-Acid SAMMS materials; Thiol-SAMMS materials; IDAA-SAMMS materials; TSA-SAMMS materials, and combinations thereof.

7. The electrochemical sensor of claim 5, wherein said SAMMS component provides said sensor with a preselected metal affinity for preconcentration of a preselected metal(s).

8. The electrochemical sensor of claim 1, wherein said polymer is a fluoropolymer.

9. The electrochemical sensor of claim 1, wherein said polymer is a tetrafluorethylene-containing polymer.

10. The electrochemical sensor of claim 9, wherein said tetrafluorethylene-containing polymer is NAFION® or TEFLON®.

11. The electrochemical sensor of claim 1, wherein said polymer provides said sensor with a property selected from the group consisting of: wettability; selective permeability; molecular size selectivity; chemical resistance; chemical stability; thermal stability; and combinations thereof.

12. The electrochemical sensor of claim 1, wherein said film releases said metal(s) in an acid solution that delivers a preselected electrical signal for determination of said metal(s).

13. The electrochemical sensor of claim 1, wherein said fluoropolymer provides said film with a chemical stability and chemical resistance over a pH range of from pH 1 to about pH=9.

14. The electrochemical sensor of claim 1, wherein said preselected ratio of said porous sorbent in said fluoropolymer is a SAMMS:NAFION mixture in the range from about 5%-10% (w/v).

15. The electrochemical sensor of claim 1, wherein said measurement surface of said sensor is an electrode that detects an electrical current of said metal(s) present in said film.

16. The electrochemical sensor of claim 15, wherein said electrode is selected from the group consisting of: screen-printed electrodes; glassy carbon (GC) electrodes; electrochemical devices; components thereof; and combinations thereof.

17. The electrochemical sensor of claim 1, wherein said sensor has a detection limit for said metal(s) at or below about 1 ppb.

18. The electrochemical sensor of claim 1, wherein said metal(s) is selected from the group consisting of: Group 3 to Group 16 metals, and combinations thereof.

19. The electrochemical sensor of claim 1, wherein said metal(s) is selected from the group consisting of: Pb, Cu, Hg, Cd, Ag, and combinations thereof.

20. The electrochemical sensor of claim 1, wherein said metal(s) is selected from the group consisting of: Eu, U, TI, and combinations thereof.

21. A method for making an electrochemical sensor, characterized by the steps:
applying a composite mixture on a measurement surface comprising a preselected ratio of a porous sorbent and a polymer to form a stable film thereon, wherein said polymer in said film minimizes fouling at said measurement surface by a fouling component(s) in a sample medium and said sorbent in said film preconcentrates a metal(s) from said sample medium for measurement thereof.

22. The method of claim 21, wherein the step of applying said composite mixture includes mixing 5%-10% (w/v) of a SAMMS sorbent with a liquid form of a NAFION polymer.

23. The method of claim 21, wherein said fouling component(s) in said sample medium is a biofouling(s) component.

24. The method of claim 21, further including the step of releasing said metal(s) from said film that delivers a preselected electrical signal for determination of said metal(s).

25. The method of claim 21, wherein the step of applying said composite mixture includes use of a SAMMS sorbent selected from the group consisting of: AcPhos-Acid SAMMS materials; Thiol-SAMMS materials; IDAA-SAMMS materials; TSA-SAMMS materials, and combinations thereof.

26. An electrochemical sensor composition, characterized by:
a preselected ratio of a porous sorbent mixed with a preselected fluoropolymer.

27. The electrochemical sensor composition of claim 26, wherein said porous sorbent includes a self-assembled monolayer on a mesoporous support (SAMMS) material and said fluoropolymer is a perfluorinated polymer in liquid form.

28. The electrochemical sensor composition of claim 26, wherein said composition includes 5%-10% (w/v) of a SAMMS sorbent mixed with a liquid form of a NAFION polymer.

29. The electrochemical sensor composition of claim 26, wherein said composition includes 70% of a SAMMS sorbent mixed with a 30% NAFION solution (w/v).

30. The electrochemical sensor composition of claim 26, wherein said composition includes 50% of a SAMMS sorbent mixed with a 50% NAFION solution (w/v).

31. A method for using an electrochemical sensor for determining a metal(s) in a sample medium, comprising the steps:
contacting a film on a measurement surface comprising a preselected ratio of a porous sorbent composed of a self-assembled monolayer on a mesoporous support (SAMMS) and a fluoropolymer with a sample medium containing said metal(s) for a preselected time, wherein said SAMMS sorbent preconcentrates said metal(s) in said film and said fluoropolymer minimizes binding of said fouling component in said medium at said measurement surface that interferes with determination of said metal(s); and
electrochemically determining said metal(s).

32. The method of claim 31, wherein the step of electrochemically determining said metal(s) includes releasing said metal(s) preconcentrated in said SAMMS sorbent of said film in acid solution and reducing said metal(s) simultaneously on a conductive portion of said sensor using a negative potential.

33. The method of claim 32, wherein the step of electrochemically determining said metal(s) further includes quantifying said metal(s) accumulated on said conductive portion of said sensor using a voltammetric method that is proportional to a concentration of said metal(s) present in said sample medium.
